(19) United States
(12) Patent Application Publication
(10) Pub. No.: US 2002/0067827 A1
(43) Pub. Date: Jun. 6, 2002

(54) Method for preventing check fraud

(76) Inventor: James B. Kargman, Chicago, IL (US)

Correspondence Address: Howard E. Silverman, Law Offices of Dick & Harris, Suite 3800, 181 W. Madison St., Chicago, IL, 60602, US

(21) Appl. No.: 09/729,918

(22) Filed: Dec. 4, 2000

(51) Int. Cl. G09C 1/00

(52) U.S. Cl. 380/54; 283/17

(57) ABSTRACT

A method is disclosed for preventing check fraud wherein the maker or payor completes a bank check. The method comprises the steps of entering the data to be printed on the face of a check; reading the data, encrypting the data toward generating a line of machine readable symbols using a private key of a public key-private key encryption mechanism and printing the machine readable symbols containing the encrypted form of data on the face of a check. The printed machine readable symbols thus serves to permit the later detection of unauthorized changes to the check thereby identifying check fraud.

### BACKGROUND OF THE INVENTION

The present invention relates generally to banking systems and the printing and processing of checks and bank drafts, and specifically, to a method for preventing check fraud.

Both individuals and companies alike are potential victims of check fraud. Check fraud can occur in a variety of ways. In one instance, a thief may steal genuine blank checks from an account owner, complete the check naming the thief as payee, forge the account owner's signature and then present the draft for payment at a financial institution thereby stealing funds from the owner's checking account. A thief may alternatively complete the check naming a third party as payee and use the check to make a payment on behalf of the thief, again stealing from the owner's checking account.

Individuals are susceptible of having their checks stolen both at home and away where, for example, a repairman visiting one's home or office or a burglar breaking into home or office, gains access to a checkbook and steal blank checks. In many cases in an effort to disguise or delay discovery of the theft the checks stolen are removed from the back of a checkbook with the hope that the owner of the checks will not discover the missing checks for some time giving the thief the opportunity to use the checks before the owner closes the account with the financial institution.

In another case a thief may intercept a completed check by stealing mail or may even be the intended recipient of the check. In such cases the thief may modify one or more attributes of the check in an effort to steal funds from the account owner by fraud. For example, the thief may change the payment amount to increase the amount of the bank check from that as originally drafted by the account holder. In other case a thief may change the name of the payee to thereby redirect the payment and again defraud the account holder. Today it is possible to create a valid check on a personal computer, using blank check stock and special ink such that a thief can create what appears to be a real check. In addition, with desktop publishing and scanners, it is not difficult to copy and duplicate the exact signature from a real check onto fraudulent checks.

In each of the foregoing examples the theft of the check and the act of fraud is typically not uncovered, until the thief has been at least initially successful in perpetrating the fraud. Typically it's only when the account owner receives the cancelled check back from its bank and is unable to reconcile the account when attempting to balance a checkbook that the account owner discovers that an alteration has been made to the amount of a check.. Alternatively, the intended payee may send notices to the account owner stating that a bill remains unpaid when the account holder in fact had previously paid the bill by check. The account holder may then and only then learn that the check as originally written had been altered after having been mailed.

A typical bank check provided by the financial institution to the consumer includes a number of pre-printed data elements. A check number typically appears in the upper right corner and the bank's identification code, the account number and check number are typically printed in ink as numeric codes along the bottom edge of the check. These codes are printed so as to readable by automated magnetic character recognition equipment used by banks to process checks.

These pre-printed codes permit and facilitate the automated processing of a check by the financial institution and are critical, if not essential, to the operation of such institutions if they are to effectively handle a large volume of bank drafts and checks which typically traverse the banking system each day. Additional fields are left blank on the face of the check providing for the standardized entry of the name of the payee, the amount of the draft, the date issued and the account owner's signature.

When a completed check or bank draft is presented for payment, the check and particularly the essential data thereon as completed by the account owner is typically examined only superficially to determine that the document is intact and that each of the blank portions of the check have been completed. For example, an examination takes place to ensure that the check has been signed by the maker. In the event that the cursory review by the bank reveals that the check is either incomplete or illegible, the check will not be honored and will be returned to the account owner. At the time of processing any attempted fraud may or may not be detected. If each of the fields of the check appear to be correct and there is no obvious visible sign of fraud the check will likely be processed by the banking institution and it is left to the account owner to discover and address the fraud with the bank or authorities.

When fraud is later detected by the account owner the owner must still go through the time and trouble of proving that a fraud has indeed taken place and must meet the requirements imposed by the financial institution to recover the monies that where fraudulently withdrawn from the owner's account.

Accordingly, it's an object of the invention to provide a method by which the integrity of the data entered on the face of a bank check by the account owner can be maintained and secured.

It is further an object of the present invention to provide a method by which any attempted check fraud may be easily discovered before payment is made on the check thereby depriving a thief of the fruit of its attempted fraud.

It is also an object of the present invention to provide a method whereby a bank check is generated which contains on its face an indication that the check is secured and that any attempted alteration of the check will be discovered so as to deter any attempted fraudulent activity.

It is an additional object of the present invention to provide a method by which a banking institution can be assured of not only the integrity and security of the bank check, but also of its authenticity so as to know for certain that the check and the security measures appearing thereon truly originate with the checking account owner.

It is also an object of the present invention to provide a method to alert a potential thief that a check is secure and cannot be altered without detection, so as to deter fraud.

It is also an object of the present invention to provide a method to prevent check fraud which is readily usable by both individuals and companies alike on both personal and company checks and which can be easily integrated into the banking systems presently processing checks.

These and other objects of the present invention will become apparent to one of ordinary skill in the art in view of the specification and drawings provided herein.

### SUMMARY OF THE INVENTION

The present invention comprises a method for preventing check fraud wherein the maker or payor completes a bank check by entering into blank fields on a pre-printed check bearing at least a pre-printed account number, and specifically wherein the method comprises the steps of: entering the data to be printed on the face of a blank preprinted check; reading the data to be printed on the face of the check; encrypting the data using a private key of a public key-private key encryption mechanism generating a line of machine readable symbols to be printed on the face of the check corresponding to the encrypted data and; printing the machine readable symbols containing the encrypted form of data on the face of a check; whereby the printed machine readable symbols serves to permit the later detection of unauthorized changes to the check thereby identifying check fraud. In a preferred embodiment of the invention the machine readable symbols comprise a high density bar code symbol.

In the preferred embodiment of the invention, the maker or payor of the instrument completes a bank check by entering data into blank fields data corresponding to the check number, payee, date, and amount on a pre-printed check bearing a pre-printed account number, and the method comprises the steps of: entering the data to be printed on the face of a blank preprinted check; reading the data to be printed on the face of the check; encrypting one or more elements of data comprising check number, payee, date, amount and account number using a private key of a public key-private key encryption mechanism; generating a line of machine readable symbols to be printed on the face of the check corresponding to the encrypted data and; printing the machine readable symbols containing the encrypted form of one or more elements of data on the face of a check; whereby the printed machine readable symbols serves to permit the later detection of unauthorized changes to the check thereby identifying check fraud.

When a check is presented for payment at a bank the present method for preventing check fraud further comprises the steps of reading the data printed on the face of the check; reading the machine readable symbols printed on the face of the check; decrypting the machine readable symbols using a public key of a public key-private key encryption mechanism toward identifying the true data entered by the maker of the check; and comparing the data as read from the face of the check to the data identified by decrypting the machine readable symbols from the face of the check toward identifying any differences therebetween; whereby the identification of any differences between the data read from the face of the check with the data identified by decrypting the encrypted data signals that unauthorized changes have been made to the check thereby identifying check fraud.

### BRIEF DESCRIPTION OF THE DRAWINGS

FIG. 1 of the drawings is a front view of the face of a check specifically showing a typical machine readable high-density barcode printed on the face of the check incorporating the encrypted data elements which appear in human readable form on the face of the check;

FIG. 2 of the drawings is a flow chart of the present invention specifically illustrating the steps taken in generating a bank check according to the present invention; and

FIG. 3 of the drawings is a flow chart specifically illustrating the steps taken to read a check printed using the present invention and verifying that it does not contain any unauthorized changes.

### DETAILED DESCRIPTION OF THE DRAWINGS

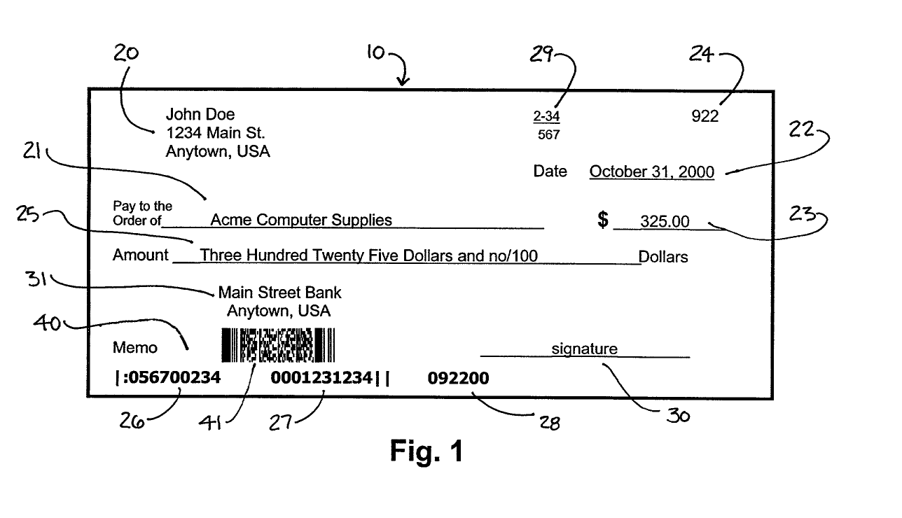

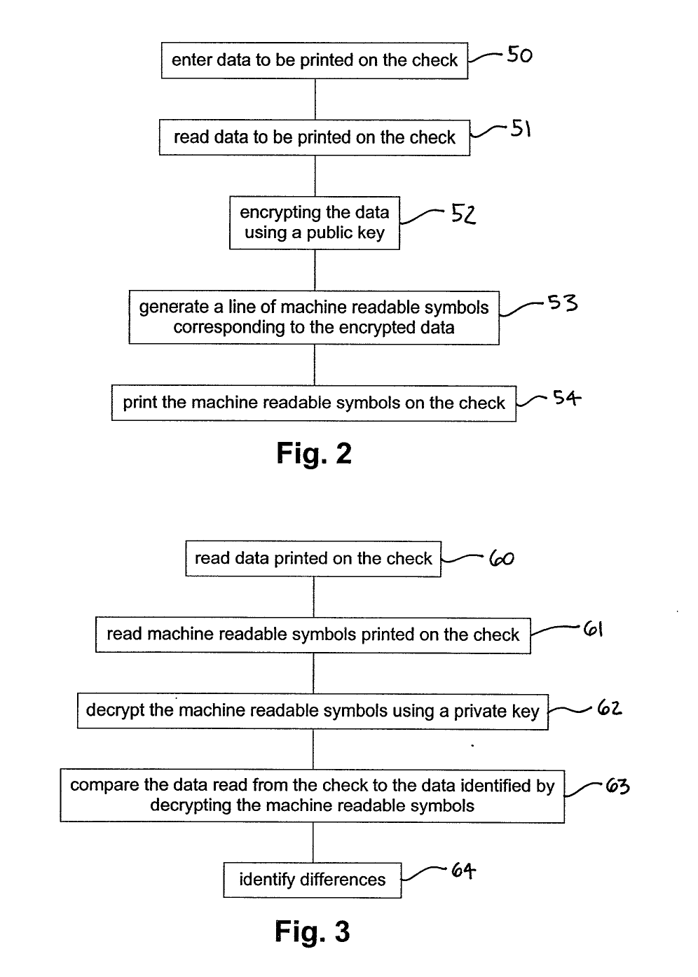

FIG. 1 of the drawings illustrates the front face of a typical bank check that is printed using the present invention as described herein. Personal checks, such as those used by individuals for paying bills and the like, typically comprise printed paper forms which include both pre-printed data corresponding or relating to the individual account owner who is the maker or named payor of the check and the bank identification number, and the bank account upon which the checks are drawn, the check sequence number, as well as blank fields which are left to be completed by the maker issuing the check.

FIG. 1 illustrates the face of check 10 completed according to the present invention and is shown including a number of different data elements. On the face of check 10 the various data items specifically include the name and address of the account owner 20, a check number 24, the name of the payee 21, the check date 22, the check amount in numerals 23, the check amount written in long hand 25, the issuing bank's identification number 29, the name of the issuing bank 31, as well as additional preprinted numeral characters 26, 27 and 28 corresponding to the bank's identity, the payor's account number and the check number, respectively. Data elements 26, 27 and 28 are typically preprinted on the check using ink that is compatible with magnetic character recognition equipment maintained by the bank and check processing facilities and which is read when processing checks. Field 30 as illustrated provides a place for the signature of the payee, which is typically intended to be the validating component of the instrument. It is recognized that a check is not valid if it is not signed by hand or machine.

Checks provided by a bank or financial printer comprise pre-printed forms having all of the above-identified data preprinted on the check with the exception of the date, payee, amounts and signature. Most individuals typically complete the check by hand providing the requisite data needed to complete and validate the instrument. Businesses typically use computer based accounting systems that include printers to complete checks by printing the required data with the checks being endorsed by hand or machine.

Field 40, typically captioned “memo” on a personal check, is provided for the check maker to insert a notation for either the maker's personal use or the payee's use to insure that proper credit is given to the payor.

The present invention addresses the shortcoming of prior art checks as described by providing an improved method of preventing check fraud through the addition of machine readable symbols 41 which are printed on the face of the check at the time the check is completed by the account owner. The maker of the check through the use of the present invention, need not rely on the banking institution identifying fraud by, for example, relying on the bank possibly noticing a minute difference in the typeface used to alter a check, or variations in sequence numbers of check numbers.

Using a public key-private key encryption mechanism in conjunction with printing a high density barcode on the face of the check at the time the check is completed by the payor, a check is created that cannot be successfully forged and which moreover is subject to easy and rapid verification by the banking institution when processing checks whereby fraudulent checks are easily identified. The method of the present invention begins with the user entering by hand or computer the data elements which need to be included on the check, step 50, including the name of the payee, the date and the amount of the check. In the case of a home or business having a computer based accounting package, this data may be entered on the computer keyboard for entry and processing by a computer software package implementing the present invention. Alternatively, the system may comprise a small portable microprocessor based terminal having an integrated printer that accepts user provided data and prints indicia in the form of a high density bar code symbol on the face of a check inserted into the terminal, similar to an check writer.

Once the data is entered, the system reads the data to be printed on the check, step 51 and proceeds to encrypt one or more elements of the data appearing on the face of the check using a public key-private key mechanism, step 52. This encrypted data is then converted into one or more machine-readable symbols corresponding to the encrypted data, step 53 which can be printed on the check.

One novel aspect of the present invention is the use of a secure encryption system that assures both security and authenticity of the check. This is accomplished by use of “keys” where one key is used to encrypt one or more data elements appearing on the face of the check and another different key is used to decrypt the data.

In its typical use a public key-private key encryption system permits a sender to send a message in secret to a recipient where the recipient is the only one who can read the message. A sender typically uses the recipient's public key to encrypt the message knowing it can be read only by the intended recipient who has the corresponding private key. While the privacy of the message is assured, the identity of the sender is not since anyone with access to the private key can send a message to the recipient.

However, according to the present invention, the one or more data elements encrypted at the time the check is written are encrypted using a private key which is known only to the account holder. The bank is given a public, or “recipient” key for use in decrypting the data encrypted with the private key. Any one of a number of available encryption mechanism, be they 56 bit or 128 bit encryption mechanisms, are contemplated for use with the present invention. It is recognized that the higher the level encryption the greater the security provided to the user, though any particular level of security is usable with the present invention provided that it still conforms to the private key-public key mechanism.

In the most secure embodiment all of the data elements on the face of the check are encoded into an encrypted barcode, though it is within the scope of the invention to encrypt fewer data elements, using, for example, only the amount and name of the payee.

The present system upon generating the machine readable symbols corresponding to the encrypted data prints the machine readable symbols 41 on the face of the check, step 54, preferably printing the symbols in the memo field 40 provided. As illustrated, symbols 41 comprise a high-density bar code symbol.

Various forms of barcode symbology may be used to print the encoded data on the face of the check.. For example, PDF417 symbology may be used to print a high-density barcode font in which hundreds of characters can be encoded in a very small space. Using error correction techniques, such as Reed Solomon, the printed symbol can even withstand damage without causing a loss of data such that handling of the check will not prevent decrypting the barcode. However, any suitable machine-readable printed indicia or symbology can be used.

According to the present invention, the bank is able to establish that the data on the face of the check has not been tampered with and that it originates with the true account owner. The barcode cannot be altered without making it impossible to decrypt. The security measures incorporated into the present invention require that the financial institution be assured that the recipient key they use to decrypt the encoded data is indeed the correct key. In so doing the bank can be assured that an impersonator has not created a message that can be decrypted using a different recipient key than the original. Therefore, it is assumed that a symmetric method be used to provide a higher security level.

FIG. 3 of the drawings illustrates the steps, which are performed by the financial institution towards identifying and preventing check fraud. Upon receiving a check for processing, the financial institution reads the data printed on the face of the check in human readable form by the check maker, step 60. This data is typically captured by the financial institution when human operators key the data into the bank's computer systems on a check-by-check basis. Alternatively, this information can be captured using optical character recognition. The machine-readable symbols are next read by the bank's system, step 61. The system converts the machine readable symbols into the encrypted form of the data and then decrypts the data using a recipient key, step 62, to thereby determine and identify the various data elements which were encrypted into the machine readable symbols. The banking system next compares the data read from the face of the check to the data identified by the decrypting of the machine-readable symbols, step 63. If the banking system cannot decrypt the data read from the machine readable symbols then it may be assumed that the symbols were generated without the proper private key corresponding to the bank's recipient key and that therefore the check was not written by the true account holder.

If however, the decryption step is successful and the data matches then the bank can be assured that none of the essential data on the check has been altered after the check was written and the encrypted machine readable symbol applied, and, moreover, that the check is authentic having been written by or with the authorization of the account holder. If there are any differences between the two data sets the data elements do not match, the check has been altered and fraud may be presumed to have been attempted.

In practice it is envisioned that the user enter the private key each time a check or group of checks are to be printed and preferably refrains from storing that key in a terminal, though it may be stored and protected by a suitable password protection mechanism. Keeping that key secret is one aspect of the present invention. It is further envisioned that the banking institution redeeming the check would use the recipient key made available by the user only to the bank to decrypt the machine readable symbols and “open” the barcode which contains one or more of the data elements encoded on the face of the check.

In operation, it is contemplated that the check number, the payee and the amount of the check be encrypted using the private key at the time the check is created and that a corresponding line of machine readable symbols is generated and printed on the face of the check. When the check is read by the financial institution during processing, the check would be honored only if the same data elements are identified as being identical between that printed on the face of the check and that encoded onto the barcode as read during the decryption of same. If a thief attempts to increase the amount of the check, alter the name of the payee or otherwise change a critical element of the check, these differences will become readily apparent when the bank is unable to match the decrypted data to the data on the face of the check and the bank has the opportunity to refuse the check as being fraudulent and not make payment thereon thus preventing check fraud.

It is contemplated that in the case of a computerized check writing system operated by a business or a home based system operated by an individual, that the machine readable symbols may be generated by that same software and printed directly onto the face of the check at the time the other data elements are prepared and printed on the check. Alternatively, in the case of individuals who do not use computerized check writing equipment, it is nevertheless contemplated that their home use computer could be easily adapted with a small piece of software which serves to accept from the user entry of the data which has been already printed on the check by hand by the user towards encrypting same generating the machine readable symbols and printing of those symbols on the face of the check.

Thus according to the present invention, the private key known only to the check maker is used by the maker to safeguard the check when it is written and the recipient key known only to the bank is used to verify that the human readable data on the face of the check has been unaltered.

Of course, should a thief steal a check and attempt to replicate a bar code from another of the account owner's checks, that bar code may pass visual inspection, but when decrypted by the bank would reveal data that did not match with that appearing on the check and the check would be refused.

It is further contemplated that the present invention has applicability not only to bank checks but also to other printed instruments and documents where it is desirable to be able to assure that what is presented is a valid instrument issued to a particular person or that the information visible on the instrument has not been altered and is what it purports to be. Examples include documents such as stock certificates, bonds and gift certificates. The present invention can be used to eliminate forgery in virtually any area where a public/private key mechanism is combined with a high-density barcode to create a document, which is virtually impossible to forge.

The foregoing description and drawings merely explain and illustrate the invention and the invention is not limited thereto except insofar as the appended claims are so limited, inasmuch as those skilled in the art, having the present disclosure before them will be able to make modifications and variations therein without departing from the scope of the invention.

What is claimed is:

1. A method for preventing check fraud wherein the maker or payor completes a bank check by entering into blank fields on a pre-printed check bearing at least a pre-printed account number, the method comprising the steps of:
entering the data to be printed on the face of a blank preprinted check;
reading the data to be printed on the face of the check;
encrypting the data toward generating a line of machine readable symbols to be printed on the face of the check using a private key of a public key-private key encryption mechanism and;
printing the machine readable symbols containing the encrypted form of data on the face of a check;
whereby the printed machine readable symbols serves to permit the later detection of unauthorized changes to the check thereby identifying check fraud.

2. The invention according to claim 1 wherein the machine readable symbols comprise a high density bar code symbol.

3. A method for preventing check fraud wherein the maker or payor completes a bank check by entering into blank fields on a pre-printed check bearing at least a pre-printed account number, the method comprising the steps of:
entering the data to be printed on the face of a blank preprinted check;
reading the data to be printed on the face of the check;
encrypting the data using a private key of a public key-private key encryption mechanism
generating a line of machine readable symbols to be printed on the face of the check corresponding to the encrypted data and;
printing the machine readable symbols containing the encrypted form of data on the face of a check;
whereby the printed machine readable symbols serves to permit the later detection of unauthorized changes to the check thereby identifying check fraud.

4. A method for preventing check fraud wherein the maker or payor of the instrument completes a bank check by entering data into blank fields data corresponding to the check number, payee, date, and amount on a pre-printed check bearing a pre-printed account number, the method comprising the steps of:
entering the data to be printed on the face of a blank preprinted check;
reading the data to be printed on the face of the check;
encrypting one or more elements of data comprising check number, payee, date, amount and account number toward generating a line of machine readable symbols to be printed on the face of the check using a private key of a public key-private key encryption mechanism and;
printing the machine readable symbols containing the encrypted form of one or more elements of data on the face of a check;
whereby the printed machine readable symbols serves to permit the later detection of unauthorized changes to the check thereby identifying check fraud.

5. A method for preventing check fraud wherein the maker or payor has completed a bank check by entering into blank fields on a pre-printed check bearing at least a pre-printed account number and which check includes on its face machine readable symbols containing the encrypted form of data entered by the maker on the face of a check, the method comprising the steps of:
reading the data printed on the face of the check;
reading the machine readable symbols printed on the face of the check;
decrypting the machine readable symbols using a public key of a public key-private key encryption mechanism toward identifying the true data entered by the maker of the check; and
comparing the data as read from the face of the check to the data identified by decrypting the machine readable symbols from the face of the check toward identifying any differences therebetween;
whereby the identification of any differences between the data read from the face of the check with the data identified by decrypting the encrypted data signals that unauthorized changes have been made to the check thereby identifying check fraud.
